(19) United States
(12) Patent Application Publication
(10) Pub. No.: US 2014/0007666 A1
(43) Pub. Date: Jan. 9, 2014

(54) MAGNETICALLY MOUNTED WIRELESS TIRE MONITORING SYSTEM

(71) Applicant: 1814393 Ontario Inc., Waterdown (CA)

(72) Inventors: Michael Kutzscher, Port Sydney (CA); Jun Feng Hu, Waterdown (CA)

(21) Appl. No.: 13/933,192

(22) Filed: Jul. 2, 2013

Related U.S. Application Data
(60) Provisional application No. 61/668,335, filed on Jul. 5, 2012.

(51) Int. Cl. B60C 23/04

(52) U.S. Cl. CPC B60C 23/0498
USPC 73/146.5; 73/146.3

(57) ABSTRACT

A tire monitoring system includes at least one magnet having an exposed face adapted to magnetically attach to an inner barrel of a vehicle wheel within a chamber created between the wheel and a vehicle tire mounted to the wheel. The magnet is connected to a tire monitoring device having a sensor contained therein. The tire monitoring device is attached to the inner barrel using the magnet and positioned in the chamber with the sensor exposed to and sensing a condition present in the chamber. The tire monitoring device can also include a wireless transmitter for wirelessly transmitting a signal indicating the condition.

### CROSS-REFERENCE TO RELATED APPLICATIONS

This application claims the benefit of U.S. Provisional Application No. 61/668,335, filed on Jul. 5, 2012. The entire disclosure of the above application is incorporated herein by reference.

### FIELD

The present disclosure relates to wireless tire monitoring systems including tire pressure and temperature monitoring systems.

### BACKGROUND

This section provides background information related to the present disclosure which is not necessarily prior art.

Tire pressure and tire temperature monitoring systems are known which include wireless systems mounted within a chamber created between a tire and a wheel. For heavy-duty, off-road vehicles, such as for front end loaders, dump trucks, mining operation vehicles, and the like, mounting the monitoring system directly to an inner wall of the tire may not be desirable when significant tire wall deflection may occur over rough surfaces, and when it is desirable to retain the monitoring system when a tire is replaced. In addition, tire monitoring systems which have been attached by a tire patch to the tire instead of the wheel are subject to failure due to the patch releasing from the tire due to improper installation.

### SUMMARY

This section provides a general summary of the disclosure, and is not a comprehensive disclosure of its full scope or all of its features.

According to several aspects, a tire monitoring system includes a magnet adapted to magnetically attach to a vehicle wheel within a chamber created between the wheel and a vehicle tire mounted to the wheel. A tire monitoring device has a sensor contained therein. The tire monitoring device is attached to the magnet and exposed to the chamber such that the sensor is exposed to and senses a condition present in the chamber.

According to several aspects, a tire monitoring system includes a strap or plate. A magnet fixed to the strap or plate has an exposed face, the exposed face adapted to magnetically attach to an inner barrel of a vehicle wheel within a chamber created between the wheel and a vehicle tire mounted to the wheel. A tire monitoring device has a sensor contained therein. The tire monitoring device is attached to the strap or plate and faces away from the exposed face of the magnet and into the chamber such that the sensor is exposed to and senses a condition present in the chamber.

According to further aspects, a tire monitoring system includes a flexible strap. Multiple magnets are fixed to the strap, each having an exposed face adapted to magnetically attach to an inner barrel of a vehicle wheel within a chamber created between the wheel and a vehicle tire mounted to the wheel. The flexible strap is adapted to flex to conform to a geometry of the inner barrel. A frame is connected to the strap. A tire monitoring device includes a sensor contained therein. The tire monitoring device is attached to the frame and faces away from the exposed face of the magnets and into the chamber such that the sensor is exposed to and senses a condition present in the chamber. The tire monitoring device further includes a wireless transmitter for wirelessly transmitting a signal indicating the condition.

According to further aspects, a tire monitoring system includes a tire monitoring device having a sensor. A magnet is magnetically attached to a metal vehicle wheel within a chamber created between the wheel and a vehicle tire mounted to the wheel. A retention device connects the magnet to the tire monitoring device with the sensor exposed to and sensing a condition present in the chamber. The tire monitoring device further has a wireless transmitter for wirelessly transmitting a signal indicating the condition.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front elevational view of a tire monitoring system connected to a flexible strap for magnetic mounting to a metal vehicle wheel;

FIG. 2 is a right front perspective view of a vehicle wheel having the tire monitoring system of FIG. 1 magnetically connected to a barrel of the wheel;

FIG. 3 is a cross sectional front elevational view taken at section III of FIG. 2;

FIG. 4 is a front elevational view of another aspect for a tire monitoring system of the present disclosure;

FIG. 5 is a front right perspective view of a vehicle having a tire/wheel assembly adapted to include a tire monitoring system of the present disclosure;

FIG. 6 is a cross sectional front elevational view similar to FIG. 3 of a tire monitoring system having magnets embedded in a strap;

FIG. 7 is a front elevational view of another aspect having a modified frame holding both a sensor and a single magnet;

FIG. 8 is a front elevational view of a tire monitoring system of another aspect;

FIG. 9 is a cross sectional plan view taken at section 9 of FIG. 8;

FIG. 10 is a front elevational view of a tire monitoring system of a further aspect;

FIG. 11 is a front elevational view similar to FIG. 10 showing displacement of the magnets;

FIG. 12 is a front elevational view of the tire monitoring system of FIG. 11 installed in a vehicle wheel;

FIG. 13 is a front elevational view of another aspect modified from FIG. 11 to include retention walls that limit displacement of the magnets;

FIG. 14 is a front elevational view of a tire monitoring system modified from FIG. 8; and

FIG. 15 is a cross sectional plan view taken at section 15 of FIG. 14.

Corresponding reference numerals indicate corresponding parts throughout the several views of the drawings.

### DETAILED DESCRIPTION

Example embodiments will now be described more fully with reference to the accompanying drawings.

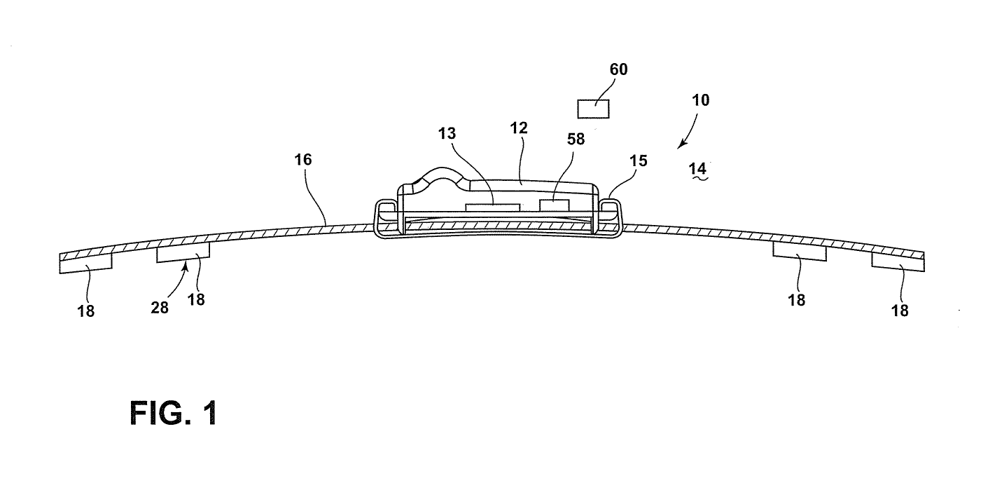

Referring to FIG. 1, a magnetic mounting tire monitoring system 10 includes a tire monitoring device 12 having a sensor 13 provided therein for sensing a condition within a chamber 14 of a tire/wheel assembly. Sensor 13 can be a computer chip or similar device and can measure a condition, such as a tire pressure or temperature, within chamber 14. Tire monitoring device 12 is connected by any connecting method to a frame 15, including by fasteners, adhesives, clamping, staking, or the like. Frame 15 is attached to a flexible strap or a short rigid plate 16, made for example of a magnetically permeable material such as a metal, a resilient material, a magnetic or magnetized material, or a flexible polymeric material. A length of the strap or plate 16 can vary depending on the application need. Frame 15 can be connected to plate or strap 16 for example by any connecting method including adhesive bonding, fastening, frictional contact, or other methods.

According to several aspects, at least one or multiple permanent magnets 18 are fixed to strap 16 and are oppositely facing with respect to tire monitoring device 12. Magnet 18 according to several aspects can extend for an entire length of or a portion of the length of plate or strap 16 for those aspects having only a single magnet 18. According to further aspects, plate or strap 16 can be a permanent magnet, or magnetized for some or all of its length. In further aspects, the long and thin geometry of strap 16 can be replaced by a “patch” having any geometry (e.g., rectangular, circular, oval, triangular, or the like) that either provides a plate similar in function to plate or strap 16 having a magnet equal in area to the plate/patch, or the patch can itself be the magnet, entirely or partially magnetized, eliminating the need for the strap. The quantity, magnetic strength, material, shape, and locations of magnets 18 can therefore vary depending on the service, operating speed, and other parameters for which the tire monitoring device is intended. According to other aspects, the tire monitoring device 12 can face in the same direction as the magnets 18, or in any orientation with respect to the magnets 18 and/or the plate or strap 16 or patch.

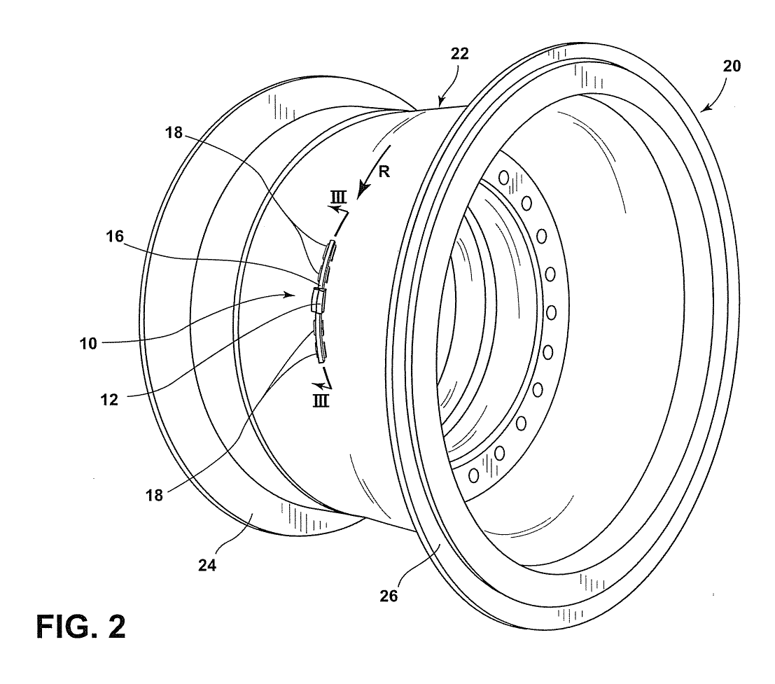

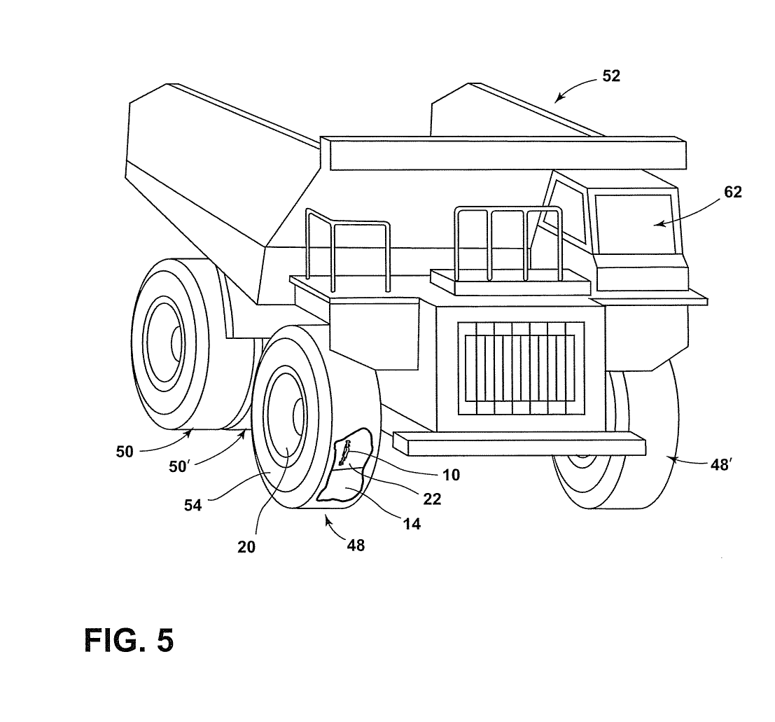

Referring to FIG. 2 and again to FIG. 1, tire monitoring system 10 is magnetically attached to a metal wheel 20 prior to or during the installation of the tire (shown in FIG. 5). The magnets 18 are positioned in parallel alignment with a rotational direction “R” of wheel 20 and directly magnetically attach to a wheel inner barrel 22, such that tire monitoring device 12 will be exposed to the conditions in the chamber 14 created between wheel 20 and a tire 54 (shown together with tire/wheel assemblies 48, 50 in FIG. 5). The chamber 14 is defined between the tire, inner barrel 22, and each of opposed first and second rims 24, 26 of wheel 20. The tire monitoring system 10 can be installed as the tire is being mounted to wheel 20 before the tire is completely mounted and a gap or space exists between the tire and wheel 20. The installer can, for example, reach through the gap by hand or with an extension tool into the tire chamber, holding the tire monitoring system 10 in proximity to inner barrel 22 to allow magnets 18 to attach. Tire monitoring system 10 can be similarly removed as the tire is being dismounted, or can be dislodged and subsequently removed from the inner chamber 14 of the tire after dismount.

According to several aspects, tire monitoring system 10 can be magnetically attached at any position of inner barrel 22 where interference with the tire sidewall will not occur. Referring again to FIG. 1, each of the magnets 18 can include an exposed face 28 that can be planar, or shaped to align with a geometry or curvature of inner barrel 22. In addition, according to several aspects, magnets 18 can also be pliable such that the exposed face 28 of each magnet can change shape during installation to adapt to the surface shape of inner barrel 22, when attached, to maximize a surface area of exposed face 28 in contact with inner barrel 22. According to several aspects, strap 16 can be flexible to adapt to the geometry of inner barrel 22, or can be rigid where its length still permits contact of magnets 18 to inner barrel 22, or to a portion of either of the first or second rims 24, 26 of wheel 20 where the tire does not contact.

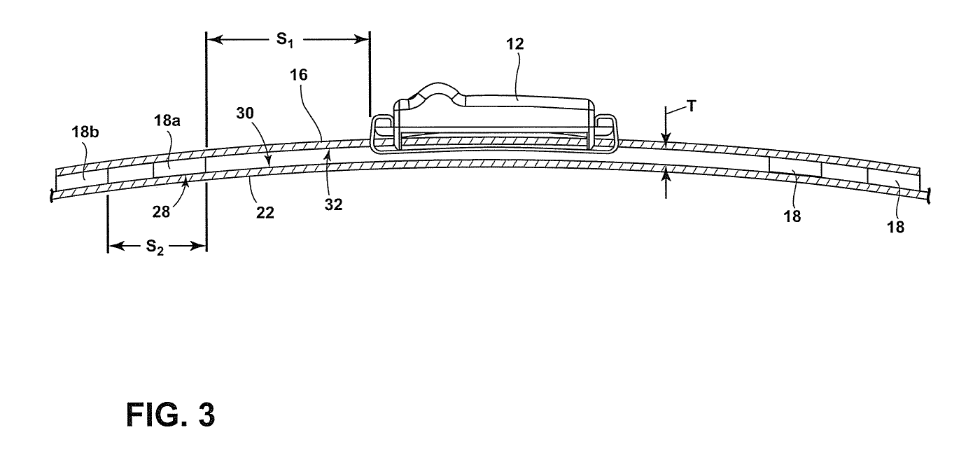

Referring to FIG. 3, in one aspect, the magnets 18 have their exposed faces 28 in direct contact with a surface 30 of inner barrel 22, thereby creating a gap “T” between surface 30 and an enclosed surface 32 of strap 16. A spacing “S₁” between tire monitoring device 12 and a closest magnet 18a can be selected to either minimize a length of strap 16, when desired, or to maximize a length of strap 16 when a greater quantity of magnets 18 is desired. A spacing “S₂” between any two successive magnets, such as between magnets 18a, 18b, can also be varied to suit the length of strap 16 and a diameter of inner barrel 22.

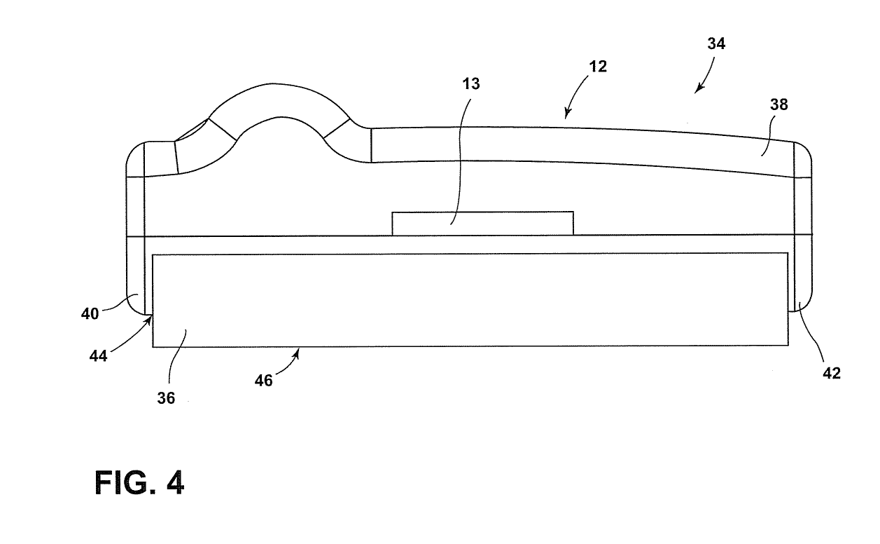

Referring to FIG. 4 and again to FIGS. 1-3, according to additional aspects, a tire monitoring system 34 is modified from tire monitoring system 10 to eliminate both frame 15 and strap 16, and can include a single magnet 36 in lieu of multiple magnets 18. A body 38 containing sensor 13 can include opposed first and second walls 40, 42 which create a cavity 44. The magnet 36 is frictionally, adhesively, or otherwise retained in cavity 44 between first and second walls 40, 42, and/or is connected to first and second walls 40, 42. An exposed face 46 of magnet 36 is positioned to make direct contact with inner barrel 22 of wheel 20, similar to exposed faces 28 of magnets 18. The tire monitoring device 12 can also be directly in contact with the magnet 36 in this system. Tire monitoring system 34 can be used in place of tire monitoring system 10, for example, when installation space is limited, for operation when low rotational tire velocities may be present that require less magnetic force to retain the tire monitoring device 12, and as a lower cost alternative.

Referring to FIG. 5 and again to FIGS. 1-4, tire monitoring system 10 (or tire monitoring system 34 not shown in this view), having tire monitoring device 12, can be used for sensing and monitoring tire pressure or other operating conditions within the inner volume or chamber 14 defined by any tire/wheel assembly of a vehicle, and particularly in slowly rotating tire/wheel assemblies, such as a front steerable tire/wheel assembly 48, 48′ or rear tire/wheel assemblies 50, 50′ of a large heavy material hauling machine 52. Each of the tire/wheel assemblies 48, 50 include a tire 54 mounted to wheel 20, thereby creating the chamber 14. With continuing reference to FIG. 1, tire monitoring device 12 further includes a wireless transmitter 58 that creates and sends a wireless transmission signal 60, indicating the condition sensed in chamber 14 by tire condition sensor 13 that can be received in a cab 62 of hauling machine 52 and monitored by an occupant of cab 62.

It is desirable to keep tire monitoring device 12 away from a liquid which may be present inside the chamber 14, that is used for example in construction and heavy duty machines like machine 52 to help cool or to provide additional sealing capability for the tires. This liquid can inhibit the sensing capability of sensor 13. By connecting tire monitoring system 10 to the wheel 20, and in particular to the inner barrel 22 of wheel 20, the tire monitoring device 12 is kept as far as possible away from the liquid in the tire, including from areas near the inner tread wall of the tire where the liquid may pool when the tire is stationary.

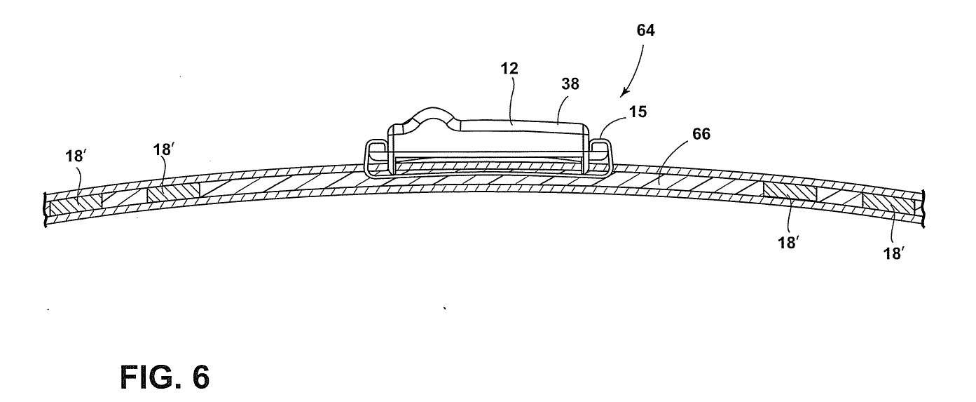

Referring to FIG. 6 and again to FIGS. 1 and 5, according to further aspects, a tire monitoring system 64 includes one or more magnets 18′ embedded partially or entirely within a strap 66, for example, by embedding magnets 18′ during a molding operation to create strap 66. When embedded entirely within strap 66, magnets 18′ are not exposed to the conditions or fluids within chamber 14 of the tire/wheel assemblies 48, 50 that the tire monitoring device 12 is exposed to. In these aspects, strap 66 can be made of a resilient material, such as rubber or a polymeric rubber compound. According to further aspects, either or both of the body 38 and/or the frame 15 can be at least partially embedded in strap 66, as well, eliminating the need for additional fasteners or adhesives to connect these components to strap 66.

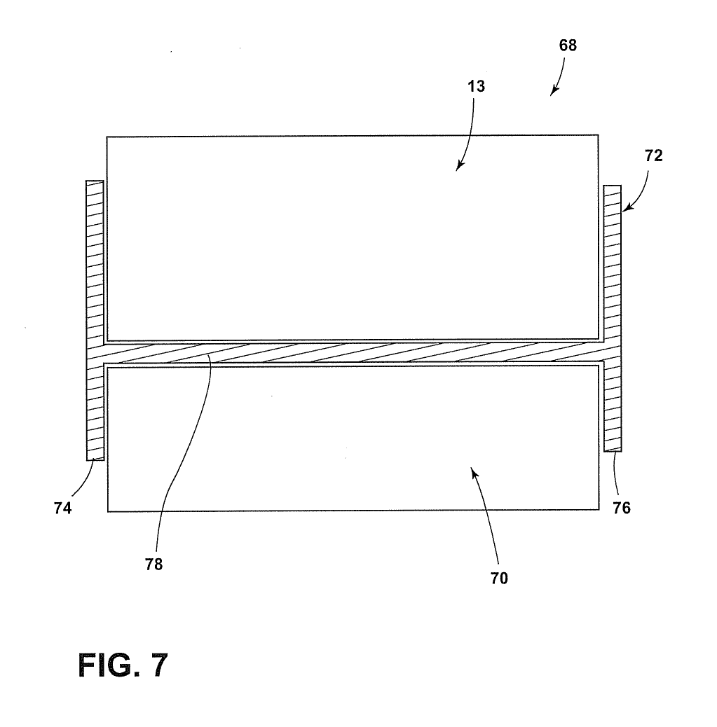

Referring to FIG. 7 and again to FIGS. 1-3, according to further aspects, a tire monitoring system 68 can include sensor 13 connected together with a single magnet 70 using a frame 72. Frame 72 captures both the sensor 13 and magnet 70 between opposed walls 74, 76 using a connecting member 78.

According to several embodiments/aspects and with reference to FIGS. 1-4 and 6, tire monitoring system 10 includes flexible strap 16. Multiple magnets 18 are fixed to the strap 16, each having their exposed face 28 adapted to directly and magnetically attach to the inner barrel 22 of the vehicle wheel 20 within the chamber 14 created between the wheel 20 and vehicle tire 54 mounted to the wheel 20. The flexible strap 16 is adapted to flex to conform to a geometry (such as a curvature) of the inner barrel 22. Frame 15 is connected to the strap 16. Tire monitoring device 12 includes sensor 13 contained therein. The tire monitoring device 12 is attached to the frame 15 and faces away from the exposed face 28 of the magnets 18 and into the chamber 14 such that the sensor 13 is exposed to and senses a condition (e.g., pressure or temperature) present in the chamber 14. The tire monitoring device 12 further includes a wireless transmitter 58 for wirelessly transmitting a signal 60, indicating the sensed condition within the chamber 14.

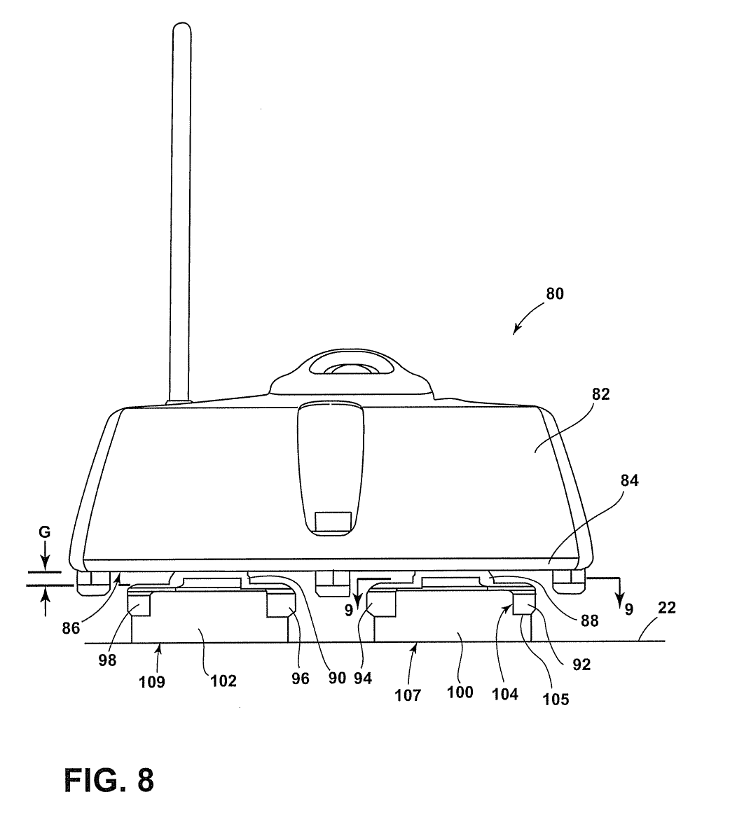

Referring to FIG. 8 and again to FIGS. 1 and 2, a magnetic mounting tire monitoring system 80 is modified from tire monitoring system 10 and includes a tire monitoring device 82 connected to a frame 84. Fixed to a first surface 86 of the frame 84 are each of a first bracket 88 and a second bracket 90, each made of a magnetically permeable metal, or of a non-magnetically permeable material. First bracket 88 includes a first wing 92 and an opposed second wing 94. Second bracket 90 similarly includes a first wing 96 and an opposed second wing 98. A first magnet 100 is retained between first and second wings 92, 94 and coupled to the material of first bracket 88. Similarly, a second magnet 102 is retained between first and second wings 96, 98 and coupled to the material of second bracket 90. Each of the first and second magnets 100, 102 has a curved outer surface that abuts a concave shaped curved surface 104 of a wing extension 105 of each of the first and second wings 92, 94 and of first and second wings 96, 98. Each of the first and second magnets 100, 102 has a substantially planar surface 107, 109 which faces oppositely away from frame 84 and is therefore available to directly contact the wheel inner barrel 22 of metal wheel 20 shown and described in reference to FIG. 2.

With reference to both FIG. 8 and again to FIG. 2, the first and second magnets 100, 102 can be positioned in parallel alignment with the rotational direction “R” of the wheel 20; however, the first and second magnets 100, 102 can also be positioned out of parallel alignment with the rotational direction “R” of the wheel 20. The first and second brackets 88, 90 extend the first and second magnets 100, 102 away from the frame 84, creating a clearance space “G”. Clearance space “G” defines an air gap allowing air flow between the first and second magnets 100, 102 and the frame 84, which allows the sensor (not shown in this view) within tire monitoring device 82 to measure a temperature closer to the true air temperature within the wheel/tire chamber 14 and lengthens a conductive path between the wheel 20, the first and second magnets 100, 102 and the frame 84 so the sensor is not directly exposed to the temperature of the wheel 20.

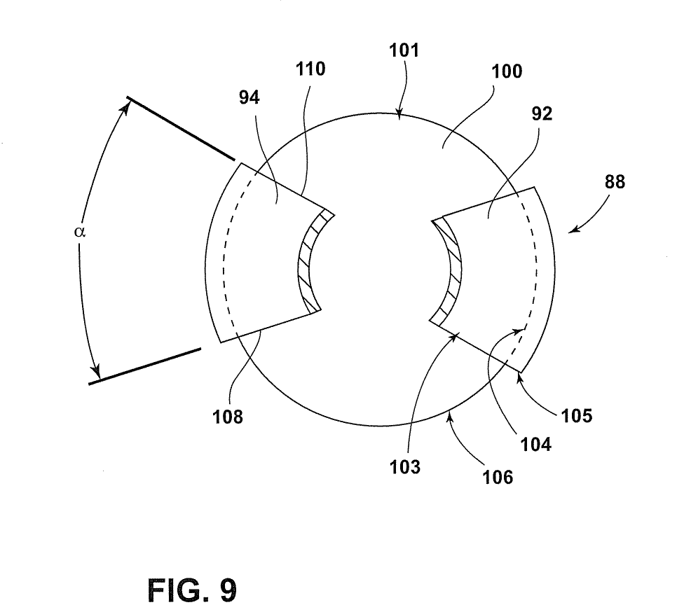

Referring to FIG. 9 and again to FIG. 8, each of the first and second wings 96, 98 of second bracket 90 are substantially identical to the first and second wings 92, 94 of first bracket 88; therefore, the following discussion of first bracket 88 applies equally to second bracket 90. The first and second wings 92, 94 are both truncated, pie-shaped members each having a substantially planar first portion 103 that abuts a planar surface 101 of first magnet 100. The concave shaped curved surface 104 of each wing extension 105 abuts an outer curved surface 106 of the first magnet 100. Each of the concave shaped curved surfaces 104 of each wing extension 105 define an arc having an angle α which acts to prevent the magnet from slipping horizontally (along a plane of the view defined by FIG. 9). Angle α is defined by first and second side walls 108, 110 of each of the first and second wings 92, 94.

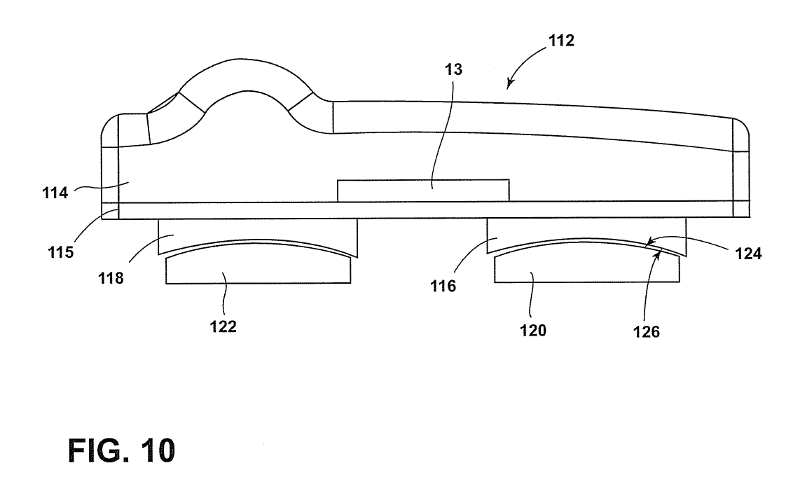

Referring to FIG. 10, a magnetic mounting tire monitoring system 112 is modified from tire monitoring systems 10 and 80, and includes a tire monitoring device 114 connected to a frame 115. Cupped first and second magnet retainers 116, 118 are each fixed to the frame 115. First and second magnets 120, 122 each include a convex shaped curved surface 124 whose curvature substantially matches a curvature of a concave shaped curved surface 126 of each of the first and second magnet retainers 116, 118. First and second magnets 120, 122 are therefore retained against the concave shaped curved surface 126 of the first and second magnet retainers 116, 118 by a magnetic force of each of the magnets.

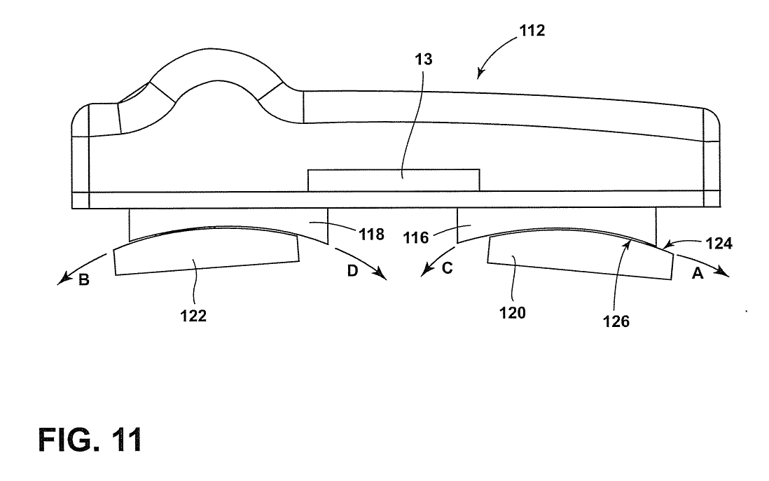

Referring to FIG. 11, the convex shaped curved surface 124 allows the first and second magnets to individually slide along the concave shaped curved surface 126 of each of the first and second magnet retainers 116, 118 such that the first and second magnets 120, 122 can seek an optimum magnetic contact position. For example, first and second magnets 120, 122 can slide outwardly (away from each other) in an outward direction “A” or “B” along the concave shaped curved surface 126 of each of the first and second magnet retainers 116, 118. First and second magnets 120, 122 can also oppositely slide inwardly (toward each other) in an inward direction “C” or “D” along the concave shaped curved surface 126 of each of the first and second magnet retainers 116, 118.

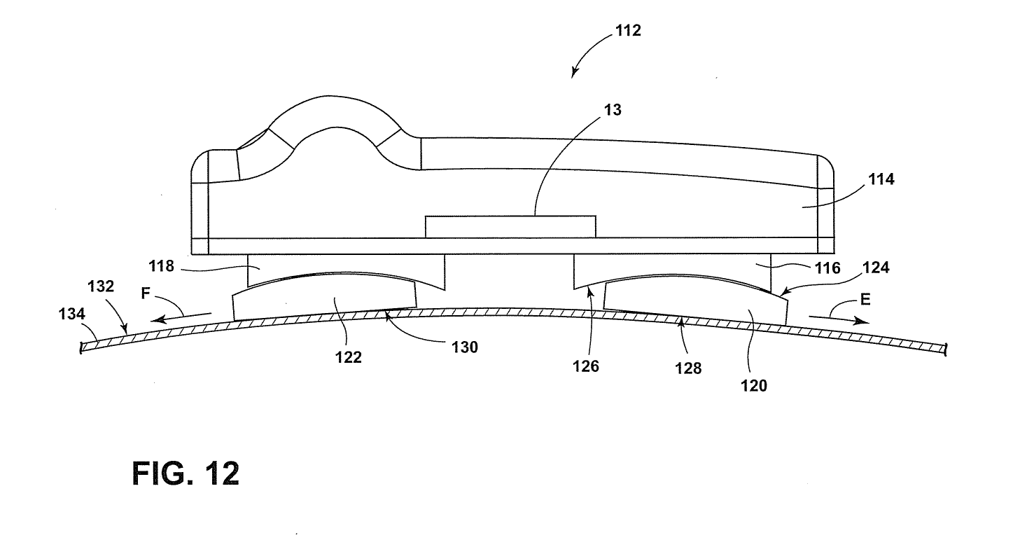

Referring to FIG. 12 and again to FIG. 11, the inward/outward sliding capability of the first and second magnets 120, 122 permits each magnet to seek or displace to a maximum location of magnetic contact with an inner surface 132 of a metal wheel 134. Each of the first and second magnets includes a substantially planar surface 128, 130 which will directly contact inner surface 132. Because a radius of curvature of the concave shaped curved surface 126 of each of the first and second magnet retainers 116, 118 is substantially less than a radius of curvature of the inner surface 132, the first and second magnets 120, 122 can slide to reach a maximum location of magnetic contact between the planar surfaces 128, 130 and inner surface 132. This also permits the tire monitoring device 114 of magnetic mounting tire monitoring system 112 to displace in either of a first direction “E” or an opposite second direction “F” while the first and second magnets 120, 122 remain substantially fixed at their locations of contact with inner surface 132.

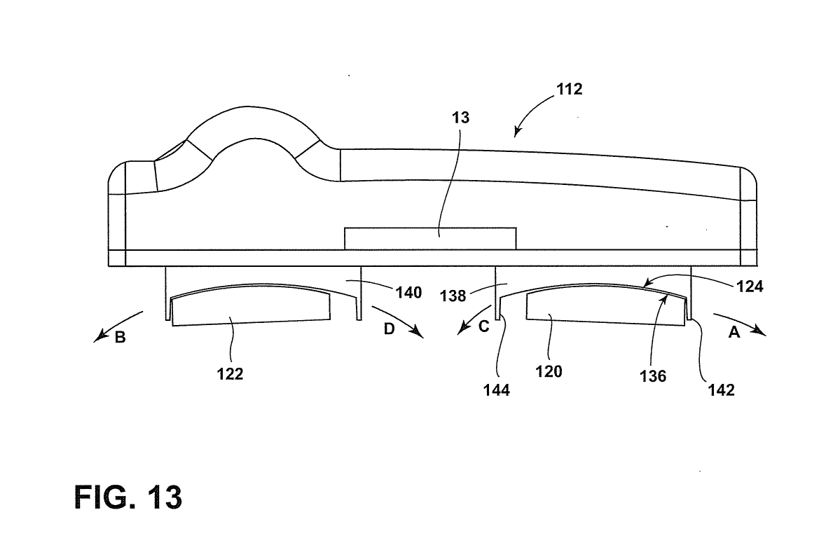

Referring to FIG. 13, according to a further aspect, the convex shaped curved surface 124 allows the first and second magnets 120, 122 to individually slide along a concave shaped curved surface 136 of each of a first and second magnet retainer 138, 140. First and second magnet retainers 138, 140 are modified from first and second magnet retainers 116, 118 to further include first and second outwardly extending retention walls 142, 144 which limit the travel of the first and second magnets 120, 122 in either the outward direction “A” or “B” or the inward direction “C” or “D”.

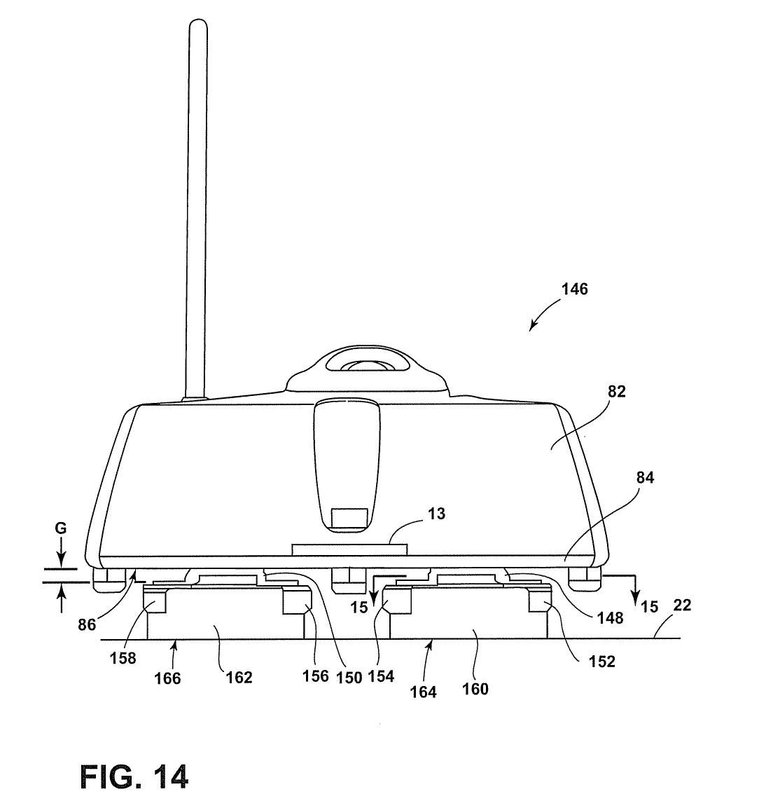

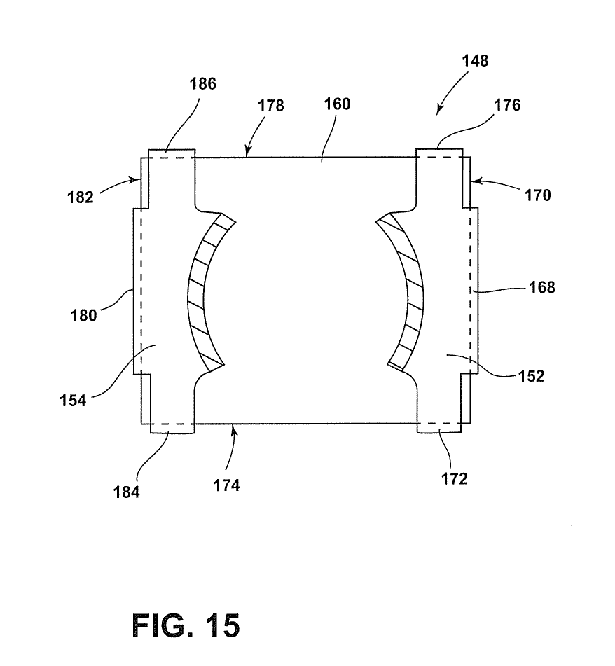

Referring to FIG. 14, and again to FIGS. 1, 2, and 8, a magnetic mounting tire monitoring system 146 is modified from tire monitoring system 80 and uses tire monitoring device 82 connected to frame 84. Fixed to the first surface 86 of the frame 84 are each of a first bracket 148 and a second bracket 150, each made of a magnetically permeable metal. First bracket 148 includes a first wing set 152 and an opposed second wing set 154. Second bracket 150 similarly includes a first wing set 156 and an opposed second wing set 158. A square or rectangular shaped first magnet 160 is retained between first and second wing sets 152, 154 and is magnetically coupled to the material of first bracket 148. Similarly, a square or rectangular shaped second magnet 162 is retained between first and second wing sets 156, 158 and is magnetically coupled to the material of second bracket 150. Each of the first and second magnets 160, 162 has a planar outer surface 164, 166 which faces oppositely away from frame 84 and therefore is available to directly contact the wheel inner barrel 22 of metal wheel 20 shown and described in reference to FIG. 2. The first and second wing sets 152, 154 and 156, 158 preclude horizontal motion of the first and second magnets 160, 162, which will be further described in reference to FIG. 15.

Referring to FIG. 15 and again to FIG. 14, the following discussion of first bracket 148 and first magnet 160 applies equally to second bracket 150 and second magnet 162, such that second bracket 150 and second magnet 162 are not further discussed. The first wing set 152 of first bracket 148 includes a first wing extension 168 which overlaps a first side wall 170 of first magnet 160. A second wing extension 172 overlaps a second side wall 174 of first magnet 160, and a third wing extension 176 overlaps a third side wall 178 of first magnet 160. The second wing set 154 is a mirror image of first wing set 152 and includes a first wing extension 180 which overlaps a fourth side wall 182 of first magnet 160. A second wing extension 184 overlaps the second side wall 174 of first magnet 160, and a third wing extension 186 overlaps the third side wall 178 of first magnet 160. The first and second wing sets 152, 154, by overlapping the four (4) walls of first magnet 160, therefore prevent sliding, horizontal displacement of the first magnet 160.

Example embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tire monitoring system, comprising:
at least one magnet adapted to magnetically attach to a metal vehicle wheel within a chamber created between the wheel and a vehicle tire mounted to the wheel; and
a tire monitoring device having a sensor contained therein, the tire monitoring device attached to the magnet and exposed to the chamber such that the sensor is exposed to and senses a condition present in the chamber.

2. The tire monitoring system of claim 1, wherein the tire monitoring device is connected to a frame, including by fasteners, adhesives, clamping, or staking.

3. The tire monitoring system of claim 2, wherein the frame is attached to one of a rigid plate or a flexible strap.

4. The tire monitoring system of claim 3, wherein the rigid plate or flexible strap is a magnetically permeable material, the magnetically permeable material is one of a metal, a resilient material, a magnetic or magnetized material, or a flexible polymeric material.

5. The tire monitoring system of claim 3, wherein the at least one magnet is connected to the plate or strap, and the plate or strap is positioned in alignment with a rotational direction of the wheel.

6. The tire monitoring system of claim 1, wherein the tire monitoring device includes a body containing the sensor and further including a cavity having the at least one magnet positioned in the cavity.

7. The tire monitoring system of claim 1, wherein the at least one magnet comprises first and second magnets individually retained by one of a first or a second bracket connected to the tire monitoring device.

8. The tire monitoring system of claim 7, wherein each of the first and second brackets includes opposed first and second wings together acting to retain one of the first or second magnets.

9. The tire monitoring system of claim 7, wherein the first and second brackets retain one of the first and second magnets and each further include opposed first and second wings and opposed third and fourth wings oriented orthogonally with respect to the first and second wings.

10. The tire monitoring system of claim 1, wherein the at least one magnet comprises first and second magnets individually magnetically coupled to one of a first and a second magnet retainer fixed to the tire monitoring device.

11. The tire monitoring system of claim 10, wherein:
each of the first and second magnets includes a convex shaped curved surface; and
each of the first and the second magnet retainers includes a concave shaped curved surface slidably receiving the convex shaped curved surface of one of the first or second magnets, thereby allowing the first and second magnets to slidably displace along one of the concave shaped curved surfaces.

12. The tire monitoring system of claim 11, wherein each of the first and second magnet retainers includes opposed first and second retention walls acting to limit the sliding displacement of the first or second magnets.

13. The tire monitoring system of claim 10, wherein each of the first and second magnets has a substantially planar surface which faces oppositely away from the frame and is positioned to directly contact a wheel inner barrel of the metal wheel.

14. The tire monitoring system of claim 1, wherein the tire monitoring device further includes a wireless transmitter for wirelessly transmitting a signal indicating the condition.

15. A tire monitoring system, comprising:
a strap;
at least one magnet fixed to the strap having an exposed face, the exposed face adapted to magnetically attach to an inner barrel of a metal vehicle wheel within a chamber created between the wheel and a vehicle tire mounted to the wheel; and
a tire monitoring device having a sensor contained therein, the tire monitoring device attached to the strap and exposed to the chamber such that the sensor is exposed to and senses a condition present in the chamber.

16. The tire monitoring system of claim 15, wherein the tire monitoring system is magnetically attached by the at least one magnet to the inner barrel of the wheel prior to or during installation of the tire on the wheel.

17. The tire monitoring system of claim 15, wherein the at least one magnet comprises first and second magnets, the strap positioned having the first and second magnets in alignment with a rotational direction of the wheel.

18. The tire monitoring system of claim 15, wherein the at least one magnet comprises at least two magnets positioned on opposite sides of the tire monitoring device, the strap positioned having the magnets in alignment with a rotational direction of the wheel.

19. The tire monitoring system of claim 15, wherein the tire monitoring device further includes a wireless transmitter for wirelessly transmitting a signal indicating the condition.

20. A tire monitoring system, comprising:
a tire monitoring device having a sensor;
first and second magnets adapted to magnetically attach to a vehicle metal wheel within a chamber created between the wheel and a vehicle tire mounted to the wheel;
a retention device connecting the first and second magnets to the tire monitoring device with the sensor exposed to and sensing a condition present in the chamber; and
the tire monitoring device further having a wireless transmitter for wirelessly transmitting a signal indicating the condition.

21. The tire monitoring system of claim 20, wherein the retention device includes a first bracket and a second bracket fixed to a first surface of the tire monitoring device, the first bracket retaining the first magnet and the second bracket retaining the second magnet.

22. The tire monitoring system of claim 21, wherein each of the first and second brackets includes a first and an opposed second wing, the first and second wings configured to retain a circular shaped perimeter of the first and second magnets.

23. The tire monitoring system of claim 21, wherein each of the first and second brackets includes a first and an opposed second wing set, the first and second wing sets configured to retain each of four walls of a rectangular shaped perimeter of the first and second magnets.

24. The tire monitoring system of claim 21, wherein each of the first and second brackets includes a first wing and an opposed second wing having one of the first or second magnets both frictionally retained between the first and second wings and magnetically coupled to first or second bracket.
